(19) United States
(12) Patent Application Publication
(10) Pub. No.: US 2015/0023320 A1
(43) Pub. Date: Jan. 22, 2015

(54) COMMUNICATION CONTROL METHOD, BASE STATION, HOME BASE STATION, AND GATEWAY DEVICE

(71) Applicant: KYOCERA CORPORATION, Kyoto (JP)

(72) Inventors: Atsuhisa Inakoshi, Kawasaki-shi (JP); Kugo Morita, Yokohama-shi (JP); Masato Fujishiro, Yokohama-shi (JP)

(73) Assignee: KYOCERA CORPORATION, Kyoto (JP)

(21) Appl. No.: 14/383,617

(22) PCT Filed: Mar. 12, 2013
(86) PCT No.: PCT/JP2013/056836

§ 371 Date: Sep. 8, 2014

Related U.S. Application Data
(60) Provisional application No. 61/612,537, filed on Mar. 19, 2012.

(51) Int. Cl. H04W 36/14

(52) U.S. Cl. CPC H04W 36/14
USPC 370/331

(57) ABSTRACT

A communication control method includes: an establishment step of establishing, between a home base station selected from a plurality of home base stations in control of a gateway device and other base station not in control of the gateway device, a communication path which passes through the gateway device and which does not pass through a core network; and a step of performing inter-base station communications using the communication path established in the establishment step, by the selected home base station and the other base station.

### TECHNICAL FIELD

The present invention relates to a communication control method, a home base station, and a gateway device in a mobile communication system.

### BACKGROUND ART

In 3GPP (3rd Generation Partnership Project), which is a project aiming to standardize a mobile communication system, specifications of a home base station, which is a small base station provided in a home or a company, and those of a gateway device that manages a plurality of home base stations are discussed (see Non-patent Document 1).

Such a gateway device can manage a subordinate home base station in place of a mobility management device provided in a core network (a core network device), and therefore, the load on a core network can be reduced.

### PRIOR ART DOCUMENT

### Non-Patent Document

Non-patent Document 1: 3GPP technical specification “TS 36.300 V11.0.0” December, 2011

### SUMMARY OF THE INVENTION

However, a problem that exists is that when a user terminal performs a handover between a home base station in the control of a gateway device, and another base station not in the control of the gateway device, a mobility management device performs a handover-related process, and therefore, the load on the core network increases.

Thus, an object of the present invention is to provide a communication control method, a base station, a home base station, and a gateway device, with which it is possible to reduce the load on a core network.

The present invention has following features in order to solve the aforementioned problem.

A communication control method according to the present invention includes: an establishment step of establishing, between a home base station selected from a plurality of home base stations in control of a gateway device and other base station not in control of the gateway device, a communication path which passes through the gateway device and which does not pass through a core network; and a step of performing inter-base station communications using the communication path established in the establishment step, by the selected home base station and the other base station.

The establishment step may include a determination step of determining, by the home base stations, the other base station, or the gateway device, the home base station with which the communication path should be established. The determination step determines the home base station with which the communication path should be established, on the basis of an implementation status of a handover to the home base stations from the other base station, and/or an implementation status of a handover to the other base station from the home base stations.

The establishment step may include a determination step of determining, by the home base stations or the gateway device, the home base station with which the communication path should be established. The determination step determines the home base station with which the communication path should be established, on the basis of a reception status of a radio signal received in the plurality of home base stations from the other base station.

Abase station according to the present invention includes: a control unit that establishes, between a home base station selected from a plurality of home base stations in control of a gateway device and the base station not in control of the gateway device, a communication path which passes through the gateway device and which does not pass through a core network; and a communication unit that performs inter-base station communications using the communication path.

The control unit may determine the home base station with which the communication path should be established, on the basis of an implementation status of a handover to the home base stations from the other base station, and/or an implementation status of a handover to the other base station from the home base stations.

A home base station according to the present invention includes: a control unit that establishes, between the home base station in control of a gateway device and the base station not in control of the gateway device, a communication path which passes through the gateway device and which does not pass through a core network; and a communication unit that performs inter-base station communications using the communication path.

The control unit may determine whether or not to establish the communication path on the basis of an implementation status of a handover to the home base station from the other base station, and/or an implementation status of a handover to the other base station from the home base station.

The control unit may determine whether or not to establish the communication path on the basis of a reception status of a radio signal from the other base station.

A gateway device according to the present invention is a device for managing a plurality of home base stations. The device includes: a control unit that establishes, between a home base station selected from the plurality of home base stations in control of a gateway device and other base station not in control of the gateway device, a communication path which passes through the gateway device and which does not pass through a core network; and a communication unit that performs inter-base station communications using the communication path.

The control unit may determine the home base station with which the communication path should be established, on the basis of an implementation status of a handover to the home base stations from the other base station, and/or an implementation status of a handover to the other base station from the home base stations.

The control unit may determine the home base station with which the communication path should be established, on the basis of a reception status of a radio signal received in the home base stations from the other base station.

### BRIEF DESCRIPTION OF THE DRAWINGS

FIG. 1 is a configuration diagram of a mobile communication system.

FIG. 2 is a diagram for explaining an X2 interface established between MeNB and HeNB.

FIG. 3 is a protocol stack diagram of a user plane related to the X2 interface established between the MeNB and the HeNB.

FIG. 4 is a protocol stack diagram of a control plane related to the X2 interface established between the MeNB and the HeNB.

FIG. 5 is a block diagram of UE.

FIG. 6 is a block diagram of MeNB.

FIG. 7 is a block diagram of MME.

FIG. 8 is a block diagram of HeNB.

FIG. 9 is a block diagram of HeNB GW.

FIG. 10 is a flowchart of an operation led by the MeNB in an operation pattern 1.

FIG. 11 is a sequence diagram of an operation led by the MeNB in the operation pattern 1.

FIG. 12 is a flowchart of an operation led by the HeNB in the operation pattern 1.

FIG. 13 is a sequence diagram of an operation led by the HeNB in the operation pattern 1.

FIG. 14 is a flowchart of an operation led by the HeNB GW in the operation pattern 1.

FIG. 15 is a sequence diagram of an operation led by the HeNB GW in the operation pattern 1.

FIG. 16 is a flowchart of an operation led by the HeNB in an operation pattern 2.

FIG. 17 is a sequence diagram of an operation in the operation pattern 2.

FIG. 18 is a sequence diagram of an operation in an operation pattern 3.

### DETAILED DESCRIPTION OF THE EMBODIMENTS

### Overview of Embodiment

A communication control method according to the present embodiment is applicable to a mobile communication system including a plurality of home base stations in the control of a gateway device, and another base station not in the control of the gateway device. The method comprises: an establishment step of establishing a communication path passing through the gateway device and not passing through the core network, between a home base station selected from the plurality of home base stations and the other base station; and a step of performing inter-base station communication, by the selected home base station and the other base station, using the communication path established in the establishment step.

Accordingly, in a case where a user terminal performs a handover between a home base station in the control of a gateway device and another base station not in the control of the gateway device, the handover-related process can be performed by a communication path passing through the gateway device and without passing through the core network. Therefore, as the mobility management device provided in the core network is not interposed, the load on the core network can be reduced. Furthermore, a process of controlling the inter-base station interference can also be performed by using the communication path.

### Embodiments

In the present embodiment, an example of a mobile communication system configured on the basis of 3GPP standards (that is, LTE-Advanced) after release 10 will be described.

Hereinafter, (1) Overview of mobile communication system, (2) Block configuration, (3) Operation, and (4) Conclusion of embodiment will be sequentially described.

(1) Overview of Mobile Communication System

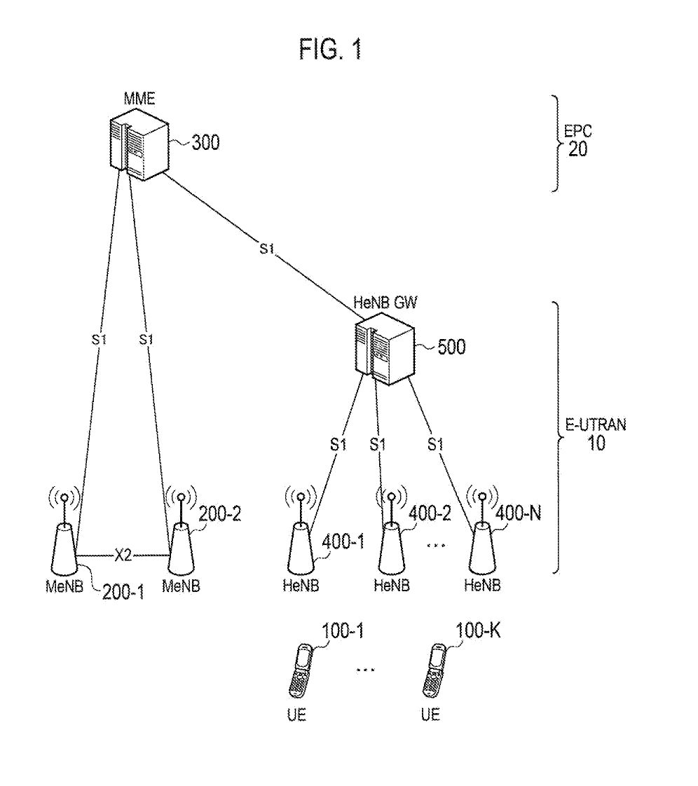

FIG. 1 is a configuration diagram of a mobile communication system according to the present embodiment. As illustrated in FIG. 1, the mobile communication system includes a user terminal (UE: User Equipment) 100, a macro base station (MeNB: Macro evolved Node-B) 200, a mobility management device (MME: Mobility Management Entity) 300, a home base station (HeNB: Home evolved Node-B) 400, and a gateway device (HeNB GW: Home evolved Node-B Gateway) 500.

Each of the MeNB 200, the HeNB 400, and the HeNB GW 500 is a network device included in a radio access network (E-UTRAN: Evolved-UMTS Terrestrial Radio Access Network) 10. The MME 300 is a network device included in a core network (EPC: Evolved Packet Core) 20.

The UE 100 is a mobile radio communication device carried by a user. The UE 100 performs radio communication with a cell (called a “serving cell”), with which a connection is established, in a connected state corresponding to a state during communication. When the UE 100 moves together with the movement of a user, a change in the serving cell of the UE 100 is necessary. A process in which the UE 100 changes the serving cell in an RRC connected state, is called “handover”.

The MeNB 200 is a large stationary radio communication device installed by an operator. The MeNB 200 forms one macro cell or a plurality of macro cells. The MeNB 200 performs radio communication with the UE 100. Furthermore, the MeNB 200 communicates with the EPC 20 through an S1 interface that is a logical communication path between the MeNB 200 and the EPC 20. Specifically, the MeNB 200 communicates with the MME 300 through an S1-MME interface which is a kind of the S1 interface. Moreover, the MeNB 200 performs inter-base station communication with an adjacent MeNB 200 through an X2 interface that is a logical communication path between the MeNB 200 and the adjacent MeNB 200.

The MME 300 is provided corresponding to a control plane dealing with control information, and performs various types of mobility management or verification processes for the UE 100.

The HeNB 400 is a small stationary radio communication device installable within the house. The MeNB 200 forms a specific cell having a coverage narrower than that of a macro cell. The specific cell is called a “CSG (Closed Subscriber Group) cell”, a “hybrid cell”, or an “open cell” according to a set access mode.

The CSG cell is a cell accessible only by UE 100 (called a “member UE”) having an access permission, and broadcasts CSG ID. The UE 100 holds a list (called a “white list”) of CSG ID for which the UE 100 has an access permission, and determines the presence or absence of access permission on the basis of the white list, and the CSG ID broadcasted by the CSG cell.

The hybrid cell is a cell in which the member UE is more advantageously treated as compared with a non-member UE, and broadcasts information, which indicates that the hybrid cell is a cell released to the non-member UE, in addition to the CSG ID. The UE 100 determines the presence or absence of access permission on the basis of the white list, and the CSG ID broadcasted by the hybrid cell.

The open cell is a cell in which the UE 100 is equally treated regardless of a member or not, and does not broadcast the CSG ID. In the perspective of UE, the open cell is similar to the macro cell.

The HeNB 400 communicates with the MME 300 passing through the HeNB GW 500 through the S1 interface (the S1-MME interface). However, when the S1 interface without passing through the HeNB GW 500 is established between the HeNB 400 and the MME 300, the HeNB 400 is able to directly communicate with the MME 300, without undergoing the HeNB GW 500.

The HeNB GW 500 manages a set of a plurality of HeNBs 400 between the EPC 20 (the MME 300) and the plurality of HeNBs 400. In view of the MME 300, the HeNB GW 500 is equal to the HeNB 400. On the other hand, in view of the HeNB 400, the HeNB GW 500 is equal to the MME 300. The HeNB GW 500 communicates with the MME 300 as a representative of the plurality of HeNBs 400, thereby reducing traffic to be transmitted to/received from the MME 300. Furthermore, the HeNB GW 500 is able to relay data from one HeNB 400 in the control of the HeNB GW 500 to another HeNB 400.

In the present embodiment, after the HeNB GW 500 establishes an X2 interface between the HeNB GW 500 and at least one MeNB 200, the X2 interface passing through the HeNB GW 500 is established between the MeNB 200 and at least one HeNB 400.

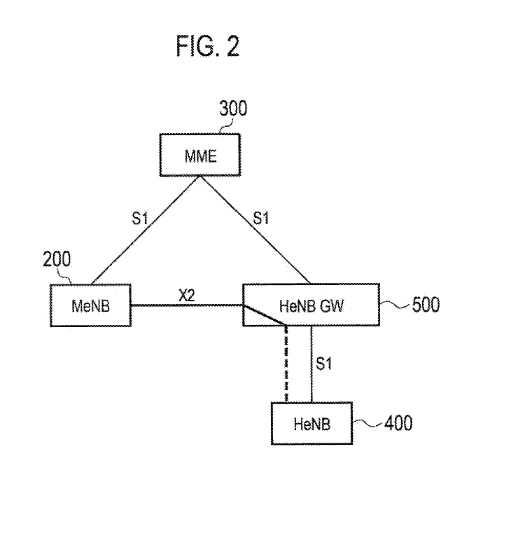

FIG. 2 is a diagram for explaining an X2 interface established between the MeNB 200 and the HeNB 400. The HeNB GW 500 is connected to the MeNB 200 through the X2 interface. Hereinafter, a connection through the X2 interface will be referred to as an “X2 connection”. Furthermore, the HeNB GW 500 is connected to a plurality of HeNBs 400 through an S1 interface. Hereinafter, a connection through the S1 interface will be referred to as an “S1 connection”.

As illustrated in FIG. 2, an X2 interface passing through the HeNB GW 500 and without passing through the EPC 20 (MME 300) is established between the HeNB 400 selected from a plurality of HeNBs 400 in the control of the HeNB GW 500 and the MeNB 200 not in the control of the HeNB GW 500. Accordingly, the selected HeNB 400 and the MeNB 200 perform inter-base station communication using the established X2 interface.

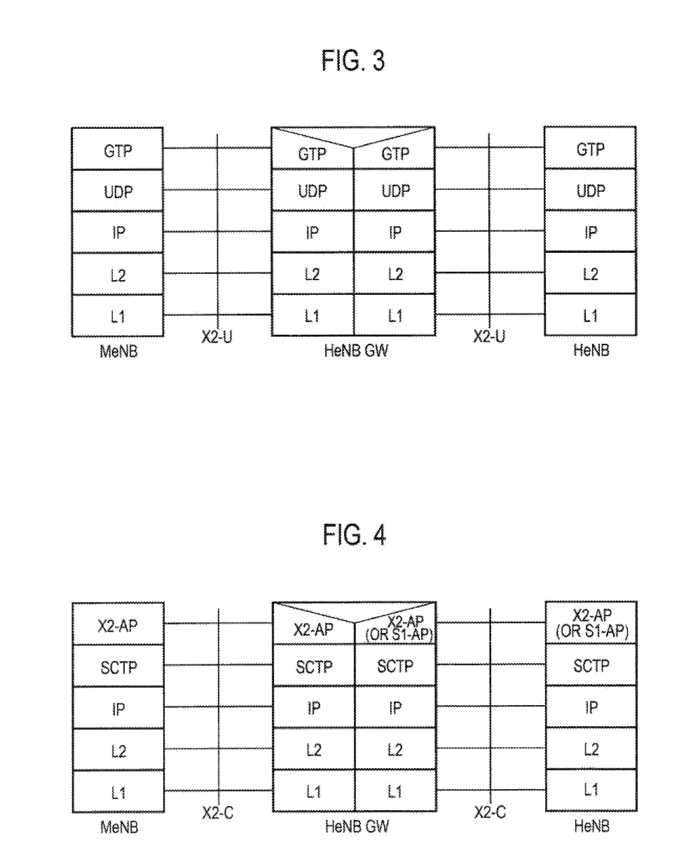

FIG. 3 and FIG. 4 are protocol stack diagrams related to the X2 interface established between the MeNB 200 and the HeNB 400.

As illustrated in FIG. 3, as regards the user plane handling user data, an IP (Internet Protocol) and a UDP (User Datagram Protocol) are provided on a layer 1 (L1) and a layer 2 (L2), and a GTP (GPRS Tunneling Protocol) is provided on the UDP.

As illustrated in FIG. 4, as regards the control plane, an IP and an SCTP (Stream Control Transmission Protocol) are provided on the L1 and the L2, and X2-AP (X2 Application Protocol) is provided on the SCTP. The X2-AP performs a handover-related process and a process of controlling inter-base station interference.

For example, as the handover-related process, the X2-AP performs a handover procedure including a handover request (Handover Request), a handover response (Handover Request ACK/NACK), and the like. Furthermore, as the process of controlling the inter-base station interference, the X2-AP performs a Load Indication procedure of transmitting/receiving the interference control information. For details of the X2-AP, for example, refer to 3GPP technology specifications “TS 36.423 V10.1.0”.

S1-AP may be provided between the HeNB 400 and the HeNB GW 500, and in the HeNB GW 500, a conversion from the S1-AP to the X2-AP, and a conversion from the X2-AP to the S1-AP may be performed.

(2) Block Configuration

Hereinafter, the block configurations of the UE 100, the MeNB 200, the MME 300, the HeNB 400, and the HeNB GW 500 will be described.

(2.1) UE

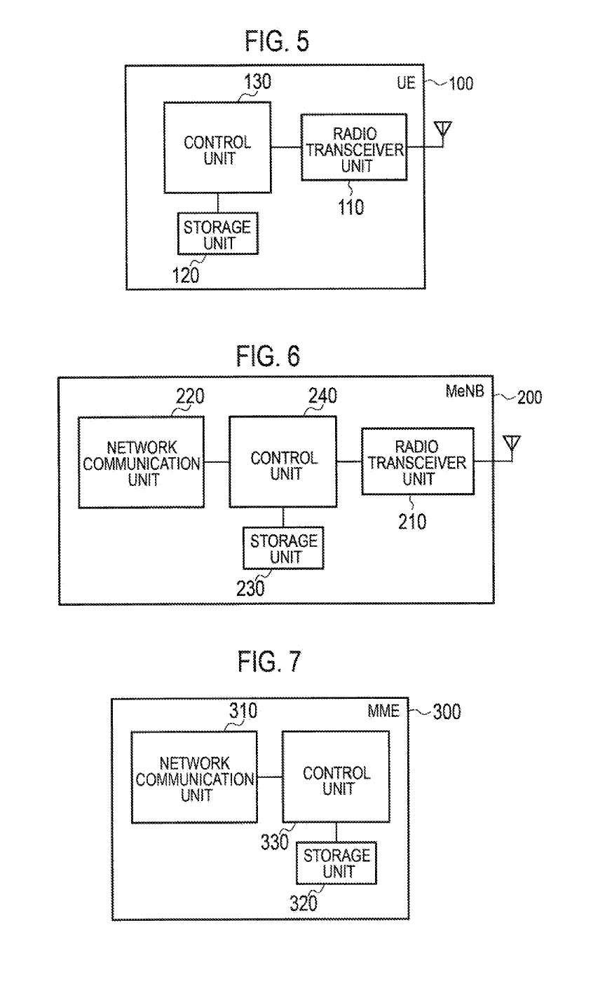

FIG. 5 is a block diagram of the UE 100. As illustrated in FIG. 5, the UE 100 includes a radio transmission/reception unit 110, a storage unit 120, and a control unit 130.

The radio transceiver unit 110 transmits/receives a radio signal.

The storage unit 120 stores various types of information that is used for the control by the control unit 130. The storage unit 120 stores a white list.

The control unit 130 controls various functions of the UE 100. In a connected state, the control unit 130 controls the radio transceiver unit 110 to perform radio communication with a serving cell.

In a connected state, when a CSG cell or a hybrid cell for which an access permission is available is detected on the basis of the CSG ID received from the CSG cell or the hybrid cell, and the white list, the control unit 130 performs the control for establishing a connection with the cell.

(2.2) MeNB

FIG. 6 is a block diagram of the MeNB 200. As illustrated in FIG. 6, the MeNB 200 includes a radio transceiver unit 210, a network communication unit 220, a storage unit 230, and a control unit 240.

The radio transceiver unit 210 transmits/receives a radio signal. Furthermore, the radio transceiver unit 210 forms one macro cell or a plurality of macro cells.

The network communication unit 220 performs inter-base station communication with another MeNB through the X2 interface. The network communication unit 220 communicates with the MME 300 through the S1 interface.

When an X2 interface is established between the MeNB 200 and the HeNB 400, the network communication unit 220 can perform inter-base station communication with the HeNB 400 through the X2 interface.

The storage unit 230 stores various types of information that is used for the control by the control unit 240.

The control unit 240 controls various functions of the MeNB 200. As described later in detail, the control unit 240 can perform a control for establishing the X2 interface passing through the HeNB GW 500, between the MeNB 200 and the HeNB 400.

(2.3) MME

FIG. 7 is a block diagram of the MME 300. As illustrated in FIG. 7, the MME 300 includes a network communication unit 310, a storage unit 320, and a control unit 330.

The network communication unit 310 communicates with the MeNB 200 and the HeNB GW 500 through the S1 interface.

The storage unit 320 stores various types of information that is used for the control by the control unit 330.

The control unit 330 controls various functions of the MME 300. For example, when the UE 100 performs a handover between base stations (eNBs) in which the X2 interface is not established, the control unit 330 performs the control for the handover.

(2.4) HeNB

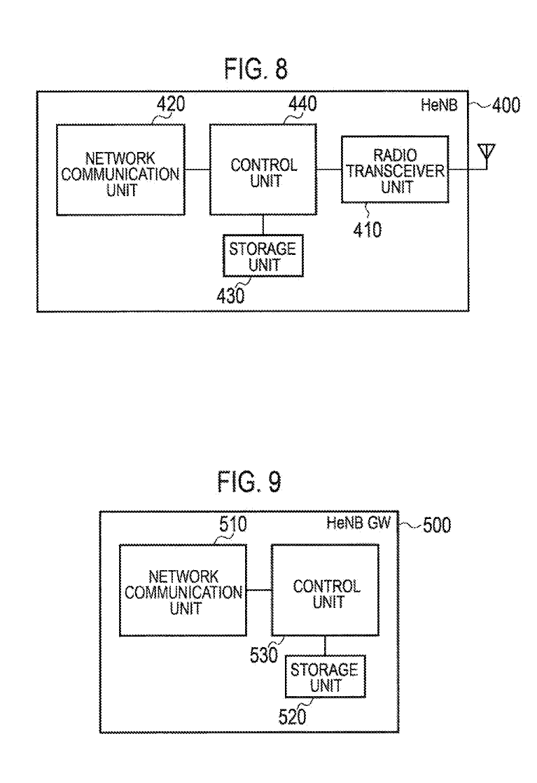

FIG. 8 is a block diagram of the HeNB 400. As illustrated in FIG. 8, the HeNB 400 includes a radio transceiver unit 410, a network communication unit 420, a storage unit 430, and a control unit 440.

The radio transceiver unit 410 transmits/receives a radio signal. Furthermore, the radio transceiver unit 410 forms a CSG cell, a hybrid cell, or an open cell.

The network communication unit 420 communicates with the HeNB GW 500 or the MME 300 through the S1 interface.

When an X2 interface is established between the HeNB 400 and the MeNB 200, the network communication unit 420 can perform inter-base station communication with the MeNB 200 through the X2 interface.

The storage unit 430 stores various types of information that is used for the control by the control unit 440.

The control unit 440 controls various functions of the HeNB 400. As described later in detail, the control unit 440 can perform a control for establishing the X2 interface passing through the HeNB GW 500, between the HeNB 400 and the MeNB 200.

(2.5) HeNB GW

FIG. 9 is a block diagram of the HeNB GW 500. As illustrated in FIG. 9, the HeNB GW 500 includes a network communication unit 510, a storage unit 520, and a control unit 530.

The network communication unit 510 communicates with the MME 300 and the HeNB 400 through the S1 interface.

The storage unit 520 stores various types of information that is used for the control by the control unit 530. In the storage unit 520, the HeNB 400 in the control of the HeNB GW 500 (that is, the HeNB 400 having an S1 connection with the HeNB GW 500) is registered.

The control unit 530 controls various functions of the HeNB GW 500. The control unit 530 manages a set of a plurality of HeNBs 400. The control unit 530 controls the network communication unit 510 to communicate with the MME 300 as a representative of the plurality of HeNBs 400.

The control unit 530 controls the network communication unit 510 to relay data from one HeNB 400 in the control of the HeNB GW 500 to another HeNB 400.

As described later in detail, the control unit 530 can perform a control for establishing the X2 interface passing through the HeNB GW 500, between the MeNB 200 and the HeNB 400.

After the X2 interface passing through the HeNB GW 500 is established between MeNB 200 and the HeNB 400, the control unit 530 controls the network communication unit 510 to relay the inter-base station communication performed between the MeNB 200 and the HeNB 400.

(3) Operation

Hereinafter, an operation of the mobile communication system according to the present embodiment will be described in the order of the operation pattern 1 through the operation pattern 3.

Although a point common to each operation pattern is that the HeNB GW 500 must have an X2 connection with any of the MeNBs 200, the determination standard of determining the HeNB 400 with which the X2 interface should be established is different.

In the operation pattern 1, the MeNB 200, the HeNB 400, or the HeNB GW 500 determines the HeNB 400 with which the X2 interface should be established on the basis of the implementation status of the handover to the HeNB 400 from the MeNB 200, and/or the implementation status of the handover to the MeNB 200 from the HeNB 400.

In the operation pattern 2, the HeNB 400 (or the HeNB GW 500) determines the HeNB 400 with which the X2 interface should be established, on the basis of the reception status of a radio signal from the MeNB 200 in the HeNB 400.

In the operation pattern 3, both the operation pattern 1 and the operation pattern 2 are used in combination.

(3.1) Operation Pattern 1

In the operation pattern 1, each of the operations led by the MeNB 200, by the HeNB 400, and by the HeNB GW 500 will be described.

(3.1.1) Operation LED by the MeNB

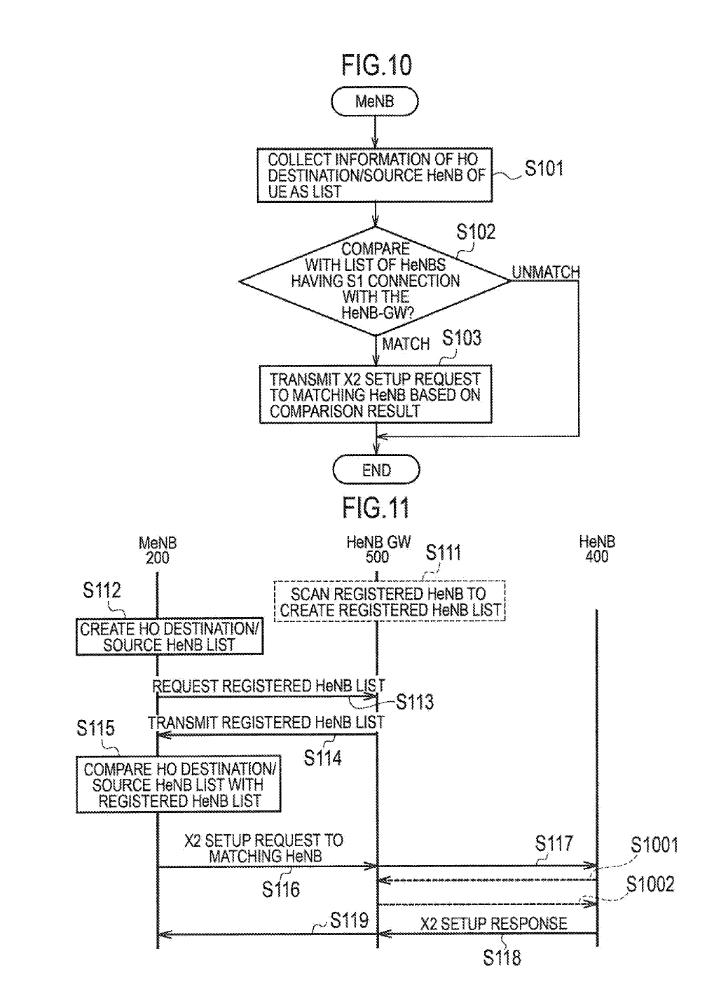

FIG. 10 is a flowchart of an operation led by the MeNB 200 in the operation pattern 1. The MeNB 200 has an X2 connection with the HeNB GW 500.

As illustrated in FIG. 10, in step S101, the MeNB 200 compiles the implementation status of a handover to the HeNB 400 from the MeNB 200, and the implementation status of a handover to the MeNB 200 from the HeNB 400. Moreover, the MeNB 200 creates a list of the handover destination HeNBs and the handover source HeNBs (hereinafter, the “HO destination/source HeNB list”).

Because a process of determining the handover destination of the UE 100 connected to the MeNB 200 is performed, the MeNB 200 can specify the handover destination HeNB of the UE 100 in the process. In addition, because a process of determining whether or not the MeNB 200 accepts a handover to the MeNB 200 from another eNB is performed, the MeNB 200 can specify the handover source HeNB of the UE 100 in the process.

In the present embodiment, the HO destination/source HeNB list includes both the handover destination HeNB information and the handover source HeNB information, but may include only either one of the handover destination HeNB information and the handover source HeNB information.

In step S102, the MeNB 200 compares the HO destination/source HeNB list created in step S101, and a list of HeNBs 400 having an S1 connection with the HeNB GW 500 (hereinafter, referred to as the “registered HeNB list”), and checks if any HeNB 400 is included commonly in each list (hereinafter, referred to as the “matching HeNB 400”).

If there is a matching HeNB 400, then in step S103, the MeNB 200 transmits X2 SETUP Request addressed to the matching HeNB 400. The X2 SETUP Request is a message for requesting the establishment of an X2 interface.

FIG. 11 is a sequence diagram of the operation led by the MeNB 200 in the operation pattern 1.

As illustrated in FIG. 11, in step S111, the HeNB GW 500 creates the above registered HeNB list.

In step S112, the MeNB 200 creates the above HO destination/source HeNB list on the basis of the implementation status of the handover to the HeNB 400 from the MeNB 200, and the implementation status of the handover to the MeNB 200 from the HeNB 400.

For example, the MeNB 200 counts the number of handovers in which the MeNB 200 is the handover destination/handover source, for each HeNB 400, and includes the HeNBs 400, for which the number exceeds a threshold value, in the HO destination/source HeNB list. Alternatively, the MeNB 200 calculates the handover frequency from the number of occurrences of a handover in which the MeNB 200 is the handover destination/handover source in a predetermined past period, for each HeNB 400, and includes the HeNBs 400, for which the frequency exceeds a threshold value, in the HO destination/source HeNB list.

In step S113, the MeNB 200 requests the HeNB GW 500 for the registered HeNB list through the X2 interface.

In step S114, in response to the request from the MeNB 200, the HeNB GW 500 transmits the registered HeNB list created in step S111 to the MeNB 200, through the X2 interface.

In step S115, the MeNB 200 compares the registered HeNB list received from the HeNB GW 500, and the HO destination/source HeNB list created in step S112, and checks if there is any matching HeNB 400. Hereinafter, the explanation is proceeded based on the assumption that a matching HeNB 400 exists.

In step S116, the MeNB 200 transmits X2 SETUP Request addressed to the matching HeNB 400, to the HeNB GW 500, through the X2 interface.

In step S117, the HeNB GW 500 transmits the X2 SETUP Request received from the MeNB 200, to the HeNB 400, through the 51 interface.

In step S118, in response to the X2 SETUP Request received from the HeNB GW 500, the matching HeNB 400 establishes an X2 interface between the matching HeNB 400 and the MeNB 200, and at the same time, transmits X2 SETUP Response, which is a response to the X2 SETUP Request, to the HeNB GW 500, through the X2 interface.

In step S119, the HeNB GW 500 transmits the X2 SETUP Response received from the HeNB 400, to the MeNB 200, through the X2 interface.

As a result of such a procedure, an X2 interface passing through the HeNB GW 500 is established for the combination of the HeNB 400 having a high handover frequency and the MeNB 200.

In this sequence, the determination subject may be changed to the HeNB GW 500 as described below.

Instead of requesting the registered HeNB list from the MeNB 200 to the HeNB GW 500 in step S113, the HO destination/source HeNB list is transmitted from the MeNB 200 to the HeNB GW 500. The HeNB GW 500 compares the received HO destination/source HeNB list, and the registered HeNB list, and checks if there is any matching HeNB 400 included commonly in each list. Then, the HeNB GW 500 transmits X2 SETUP Request to the matching HeNB 400.

In step S118, it was described that the X2 SETUP Response is transmitted through the X2 interface, however, before the step S118, the possibility of establishing an X2 connection with the HeNB 400 may be notified to the HeNB GW 500 (step S1001). Furthermore, the HeNB GW 500 may transmit a response to the notification to the HeNB 400 (step S1002).

(3.1.2) Operation LED by the HeNB

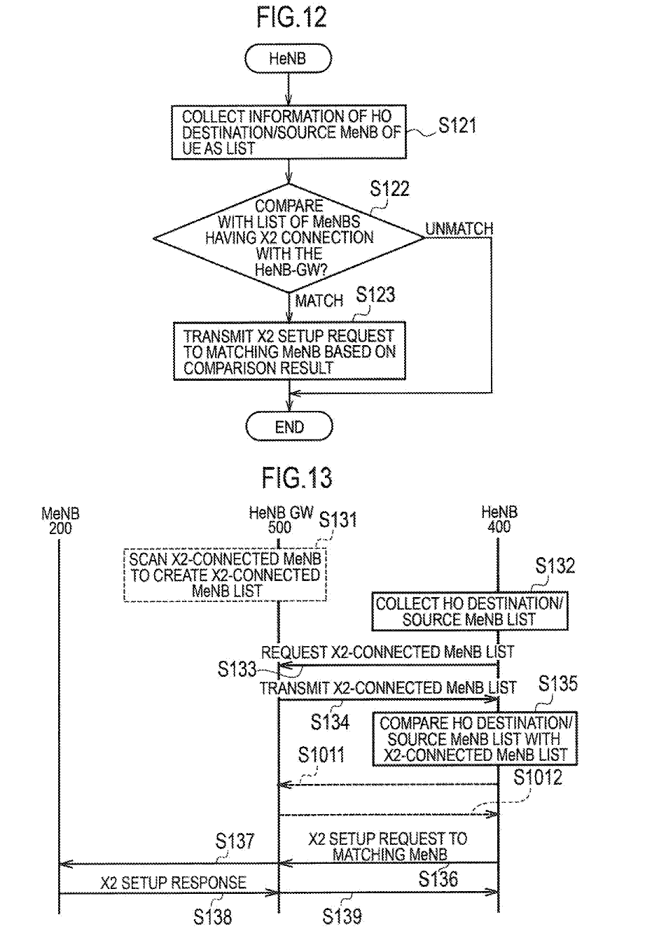

FIG. 12 is a flowchart of an operation led by the HeNB 400 in the operation pattern 1.

As illustrated in FIG. 12, in step S121, the HeNB 400 collects the implementation status of a handover to the HeNB 400 from the MeNB 200 and the implementation status of a handover to the MeNB 200 from the HeNB 400. The HeNB 400 creates a list of the handover destination MeNBs and the handover source MeNBs (hereinafter, referred to as the “HO destination/source MeNB list”).

Because a process of determining the handover destination of the UE 100 connected to the HeNB 400 is performed, the HeNB 400 can specify the handover destination MeNB of the UE 100 in the process. In addition, because a process of determining whether or not the MeNB 200 accepts a handover to the HeNB 400 from another eNB is performed, the MeNB 200 can specify the handover source MeNB of the UE 100 in the process.

In the present embodiment, the HO destination/source MeNB list includes both the handover destination MeNB information and the handover source MeNB information, but may include only either one of the handover destination MeNB information and the handover source MeNB information.

In step S122, the HeNB 400 compares the HO destination/source MeNB list created in step S121, and a list of MeNBs 200 having an X2 connection with the HeNB GW 500 (hereinafter, referred to as the “X2-connected MeNB list”), and checks if any MeNB 200 is included commonly in each list (hereinafter, referred to as the “matching MeNB 200”).

If there is a matching MeNB 200, then in step S123, the HeNB 400 transmits X2 SETUP Request addressed to the matching MeNB 200. As described above, the X2 SETUP Request is a message for requesting the establishment of an X2 interface.

FIG. 13 is a sequence diagram of the operation led by the HeNB 400 in the operation pattern 1.

As illustrated in FIG. 13, in step S131, the HeNB GW 500 creates the above X2-connected MeNB list.

In step S132, the HeNB 400 creates the above HO destination/source MeNB list on the basis of the implementation status of the handover to the HeNB 400 from the MeNB 200, and the implementation status of the handover to the MeNB 200 from the HeNB 400.

For example, the HeNB 400 counts the number of handovers in which the HeNB 400 is the handover destination/handover source, for each MeNB 200, and includes the MeNBs 200, for which the number exceeds a threshold value, in the HO destination/source MeNB list. Alternatively, the HeNB 400 calculates the handover frequency from the number of occurrences of a handover in which the HeNB 400 is the handover destination/handover source in a predetermined past period, for each MeNB 200, and includes the MeNBs 200, for which the frequency exceeds a threshold value, in the HO destination/source MeNB list.

In step S133, the HeNB 400 requests the HeNB GW 500 for the X2-connected MeNB list through the S1 interface.

In step S134, in response to the request from the HeNB 400, the HeNB GW 500 transmits the X2-connected MeNB list created in step S131 to the HeNB 400, through the S1 interface.

In step S135, the HeNB 400 compares the X2-connected MeNB list received from the HeNB GW 500, and the HO destination/source MeNB list created in step S132, and checks if there is any matching MeNB 200. Hereinafter, the explanation is proceeded based on the assumption that a matching MeNB 200 exists.

In step S136, the HeNB 400 transmits X2 SETUP Request addressed to the matching MeNB 200, to the HeNB GW 500, through the S1 interface.

In step S137, the HeNB GW 500 transmits the X2 SETUP Request received from the HeNB 400, to the MeNB 200, through the X2 interface.

In step S138, in response to the X2 SETUP Request received from the HeNB GW 500, the matching MeNB 200 establishes an X2 interface between the matching MeNB 200 and the HeNB 400, and at the same time, transmits X2 SETUP Response, which is a response to the X2 SETUP Request, to the HeNB GW 500, through the X2 interface.

In step S139, the HeNB GW 500 transmits the X2 SETUP Response received from the MeNB 200, to the HeNB 400, through the X2 interface.

It must be noted that before the HeNB 400 transmits the X2 SETUP Request in step S136, the possibility of establishing an X2 connection with the HeNB 400 may be notified to the HeNB GW 500 (step S1011). Furthermore, the HeNB GW 500 may transmit a response to the notification to the HeNB 400 (step S1012).

As a result of such a procedure, an X2 interface passing through the HeNB GW 500 is established for the combination of the HeNB 400 having a high handover frequency and the MeNB 200.

In this sequence, the determination subject may be changed to the HeNB GW 500 as described below.

Instead of requesting the X2-connected MeNB list from the HeNB 400 to the HeNB GW 500 in step S133, the HO destination/source MeNB list is transmitted from the HeNB 400 to the HeNB GW 500. The HeNB GW 500 compares the received HO destination/source MeNB list, and the X2-connected MeNB list, and checks if there is any matching MeNB 200 included commonly in each list. Then, the HeNB GW 500 transmits X2 SETUP Request to the matching MeNB 200.

(3.1.3) Operation LED by the HeNB GW

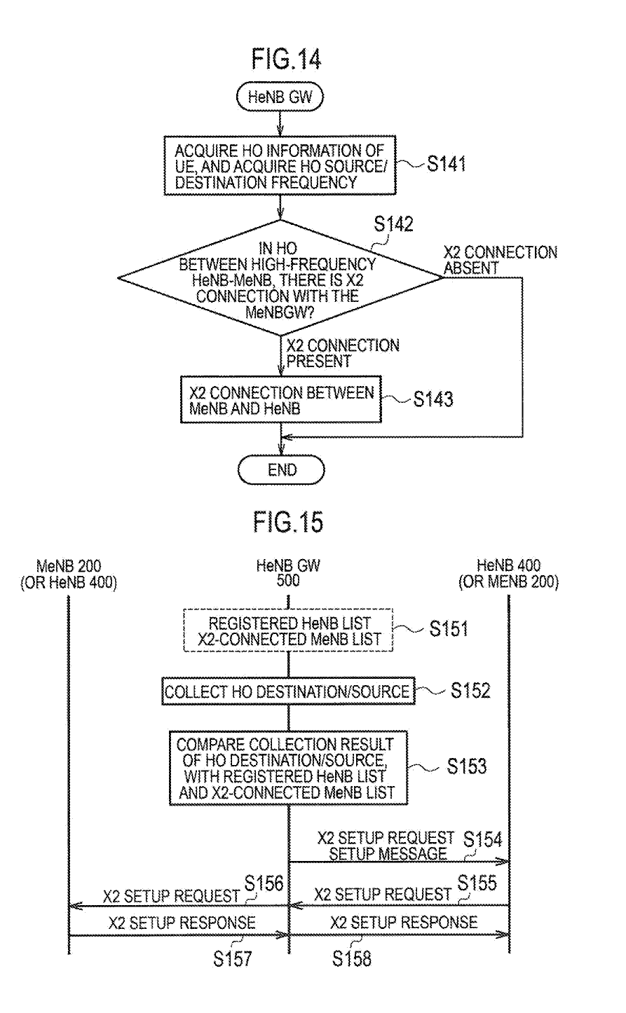

FIG. 14 is a flowchart of an operation led by the HeNB GW 500 in the operation pattern 1.

As illustrated in FIG. 14 in step S141, the HeNB GW 500 acquires the handover frequency for the combination of each MeNB 200 and each HeNB 400 (hereinafter, referred to as the “MeNB 200-HeNB 400 set”) from the implementation status of a handover to the HeNB 400 from the MeNB 200 and the implementation status of a handover to the MeNB 200 from the HeNB 400. It must be noted that because the HeNB GW 500 relays (routes) the information of a handover concerning the HeNB 400, the handover frequency can be acquired on the basis of the information.

In step S142, the HeNB GW 500 compares the handover frequency for each MeNB 200-HeNB 400 set acquired in step S141, the registered HeNB list, and the X2-connected MeNB list.

If an MeNB 200-HeNB 400 set satisfies the conditions, then in step S143, the HeNB GW 500 performs control to establish an X2 interface passing through the HeNB GW 500 for the MeNB 200-HeNB 400 set having a high handover frequency.

FIG. 15 is a sequence diagram of the operation led by the HeNB GW 500 in the operation pattern 1.

As illustrated in FIG. 15, in step S151, the HeNB GW 500 creates the above registered HeNB list and the above X2-connected MeNB list.

In step S152, the HeNB GW 500 collects the implementation status of a handover to the HeNB 400 from the MeNB 200 and the implementation status of a handover to the MeNB 200 from the HeNB 400. Then, the HeNB GW 500 acquires the handover frequency for each MeNB 200-HeNB 400 set.

In step S153, the HeNB GW 500 compares the handover frequency for each MeNB 200-HeNB 400 set, the registered HeNB list, and the X2-connected MeNB list. For example, the HeNB GW 500 checks if there is an X2 connection with the MeNB 200 and if the HeNB 400 is in the control of the HeNB GW 500, in the MeNB 200-HeNB 400 set having a high handover frequency. Hereinafter, the explanation is proceeded based on the assumption that there is an MeNB 200-HeNB 400 set satisfying the conditions.

In step S154, the HeNB GW 500 transmits an X2 SETUP Request startup message to the MeNB 200 or the HeNB 400, in the MeNB 200-HeNB 400 set satisfying the conditions. Hereinafter, the explanation is proceeded based on the assumption that an X2 SETUP Request startup message is transmitted to the HeNB 400.

The X2 SETUP Request startup message is a message that starts (requests) the X2 SETUP Request. The X2 SETUP Request startup message includes information specifying the transmission destination of the X2 SETUP Request. Thus, as regards an MeNB 200-HeNB 400 set satisfying the conditions, when an X2 SETUP Request startup message is transmitted to the HeNB 400, the X2 SETUP Request startup message includes information specifying the MeNB 200 as the transmission destination.

In step S155, the HeNB 400 that receives the X2 SETUP Request startup message transmits the X2 SETUP Request addressed to the MeNB 200 specified in the X2 SETUP Request startup message, through the 51 interface.

The following step S156 through step S158 are the same as the step S137 through the step S139 of FIG. 13.

As a result of such a procedure, an X2 interface passing through the HeNB GW 500 is established for the combination of the HeNB 400 having a high handover frequency and the MeNB 200.

(3.2) Operation Pattern 2

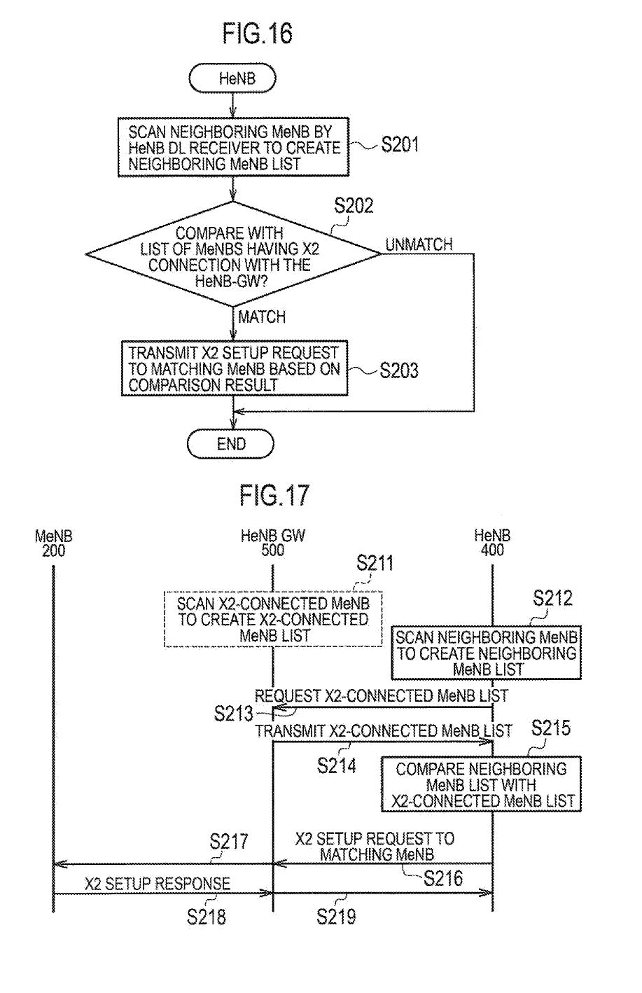

Next, the operation pattern 2 will be described. FIG. 16 is a flowchart of an operation led by the HeNB 400 in the operation pattern 2.

As illustrated in FIG. 16, in step S201, the HeNB 400 scans a radio signal from the MeNB 200. The HeNB 400 creates a list of the MeNBs 200 present near the HeNB 400 (hereinafter, referred to as the “neighboring MeNB list”) depending on the scan result.

In step S202, the HeNB 400 compares the neighboring MeNB list created in step S201, and the above X2-connected MeNB list, and checks if there is any MeNB 200 included commonly in each list (matching MeNB 200).

If there is a matching MeNB 200, then in step S203, the HeNB 400 transmits X2 SETUP Request addressed to the matching MeNB 200. As described above, the X2 SETUP Request is a message for requesting the establishment of an X2 interface.

FIG. 17 is a sequence diagram of the operation in the operation pattern 2.

As illustrated in FIG. 17, in step S211, the HeNB GW 500 creates the above X2-connected MeNB list.

In step S212, the HeNB 400 creates the above neighboring MeNB list depending on the scan result for the MeNB 200. For example, the HeNB 400 measures the received power of a reference signal received from the MeNB 200, and if the received power is equal to or greater than a predetermined level, the MeNB 200 is included in the neighboring MeNB list.

In step S213, the HeNB 400 requests the HeNB GW 500 for the X2-connected MeNB list, through the S1 interface.

In step S214, in response to the request from the HeNB 400, the HeNB GW 500 transmits the X2-connected MeNB list created in step S211, to the HeNB 400, through the S1 interface.

In step S215, the HeNB 400 compares the X2-connected MeNB list received from the HeNB GW 500, and the neighboring MeNB list created in step S212, and checks if there is any matching MeNB 200.

The following step S216 through step S219 are the same as the step S136 through the step S139 of FIG. 13.

As a result of such a procedure, an X2 interface passing through the HeNB GW 500 is established for the combination of the HeNB 400 having a close proximity (alternatively, having a high influence of interference) and the MeNB 200.

In this sequence, the determination subject may be changed to the HeNB GW 500 as described below.

Instead of requesting the X2-connected MeNB list from the HeNB 400 to the HeNB GW 500 in step S213, the neighboring MeNB list is transmitted from the HeNB 400 to the HeNB GW 500. The HeNB GW 500 compares the received neighboring MeNB list and the X2-connected MeNB list, and checks if there is any matching MeNB 200 included commonly in each list. Then, the HeNB GW 500 transmits X2 SETUP Request to the matching MeNB 200.

(3.3) Operation Pattern 3

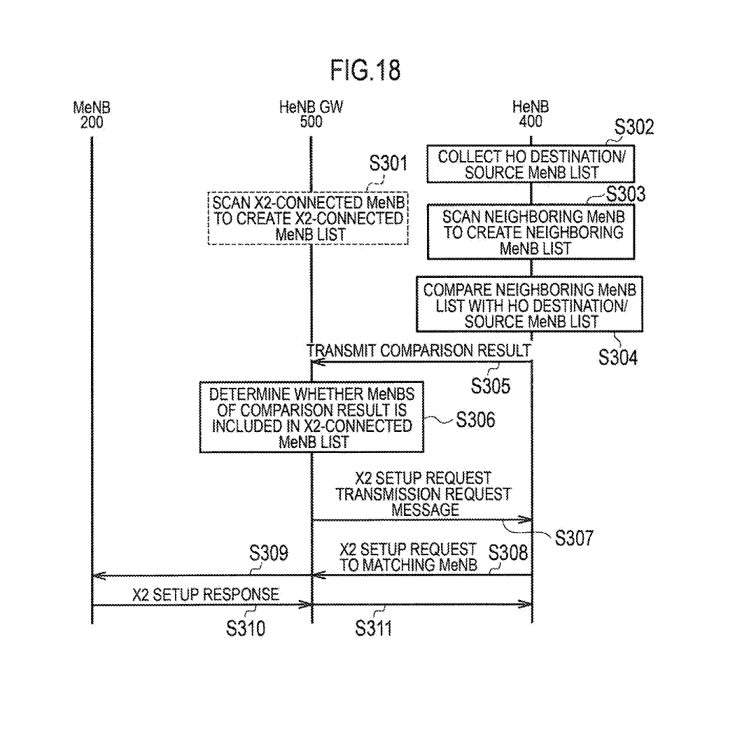

Next, the operation pattern 3 will be described. FIG. 18 is a sequence diagram of an operation in the operation pattern 3.

As illustrated in FIG. 18, in step S301, the HeNB GW 500 creates the above X2-connected MeNB list.

In step S302, the HeNB 400 creates the above HO destination/source MeNB list on the basis of the implementation status of a handover to the HeNB 400 from the MeNB 200, and the implementation status of a handover to the MeNB 200 from the HeNB 400.

In step S303, the HeNB 400 creates the above neighboring MeNB list depending on the scan result for the MeNB 200.

In step S304, the HeNB 400 compares the HO destination/source MeNB list created in step S302, and the neighboring MeNB list created in step S303. For example, the HeNB 400 extracts the MeNB 200 that is included commonly in the HO destination/source MeNB list and the neighboring MeNB list.

In step S305, the HeNB 400 transmits the comparison result in step S304 to the HeNB GW 500, through the S1 interface.

In step S306, the HeNB GW 500 checks if the MeNB 200 included in the comparison result is included in the X2-connected MeNB list on the basis of the comparison result from the HeNB GW 500 and the X2-connected MeNB list. Hereinafter, the explanation is proceeded based on the assumption that the MeNB 200 included in the comparison result is included in the X2-connected MeNB list.

In step S307, the HeNB 500 transmits an X2 SETUP Request startup message for transmitting an X2 SETUP Request to the MeNB 200 included in the comparison result and having an X2 connection, to the HeNB 400, through the S1 interface.

The following step S308 through step S311 are the same as the step S155 through the step S158 of FIG. 15.

As a result of such a procedure, an X2 interface passing through the HeNB GW 500 is established for the combination of the HeNB 400 having a high handover frequency and also a close proximity, and the MeNB 200.

(4) Conclusion of Embodiment

As described above, an X2 interface passing through the HeNB GW 500 and not passing through the EPC 20 is established between the HeNB 400 selected from a plurality of HeNBs 400 and the MeNB 200, in a mobile communication system including a plurality of HeNBs 400 in the control of the HeNB GW 500 and the MeNB 200 not in the control of the HeNB GW 500.

The selected HeNB 400 and the MeNB 200 perform inter-base station communication using the X2 interface that is established. Accordingly, by the established X2 interface, the handover-related process and the process for controlling the inter-base station interference can be performed without the interposition of the EPC 20 (MME 300).

In the present embodiment, the HeNB 400 with which the X2 interface should be established is determined on the basis of the implementation status of the handover to the plurality of HeNBs 400 from the MeNB 200, and/or the implementation status of the handover to the MeNB 200 from the plurality of HeNBs 400. Accordingly, the possibility of establishing unnecessary X2 interfaces that may not be used in the handover can be reduced. Thus, a useful X2 interface can be established between the HeNB 400 and the MeNB 200.

In the present embodiment, the HeNB 400 with which the X2 interface should be established is determined on the basis of the reception status, of a radio signal from the MeNB 200, in the plurality of HeNBs 400. Accordingly, the possibility of establishing unnecessary X2 interfaces that may not be used in the control of the inter-base station interference can be reduced. Thus, a useful X2 interface can be established between the HeNB 400 and the MeNB 200.

### Other Embodiments

Thus, the present invention has been described with the embodiments. However, it should not be understood that those descriptions and drawings constituting a part of the present disclosure limit the present invention. Further, various substitutions, examples, or operational techniques shall be apparent to a person skilled in the art on the basis of this disclosure.

For example, in the aforementioned embodiment, the MeNB 200 has been described as the base station not in the control of the HeNB GW 500. However, the base station not in the control of the HeNB GW 500 may be a Pico base station (PeNB: Pico evolved Node-B). In such a case, the X2 interface passing through the HeNB GW 500 can be established between the HeNB 400 and the PeNB. Alternatively, the base station not in the control of the HeNB GW 500 may be the HeNB in the control of another HeNB GW. In such a case, the X2 interface passing through the HeNB GW 500 can be established between the HeNB 400 in the control of the HeNB GW 500 and the HeNB in the control of another HeNB GW.

The entire contents of U.S. Provisional Application No. 61/612,537 (filed on Mar. 19, 2012) are incorporated herein by reference.

### INDUSTRIAL APPLICABILITY

As described, the present invention is useful in mobile communication fields.

1. A communication control method applied to a mobile communication system, comprising:
an establishment step of establishing, between a home base station selected from a plurality of home base stations in control of a gateway device and other base station not in control of the gateway device, a communication path which passes through the gateway device and which does not pass through a core network; and
a step of performing inter-base station communications using the communication path established in the establishment step, by the selected home base station and the other base station.

2. The communication control method according to claim 1, wherein
the establishment step comprises a determination step of determining, by the home base stations, the other base station, or the gateway device, the home base station with which the communication path should be established, and
the determination step determines the home base station with which the communication path should be established, on the basis of an implementation status of a handover to the home base stations from the other base station, and/or an implementation status of a handover to the other base station from the home base stations.

3. The communication control method according to claim 1, wherein
the establishment step comprises a determination step of determining, by the home base stations or the gateway device, the home base station with which the communication path should be established, and
the determination step determines the home base station with which the communication path should be established, on the basis of a reception status of a radio signal received in the plurality of home base stations from the other base station.

4. A base station applied to a mobile communication system, comprising:
a control unit that establishes, between a home base station selected from a plurality of home base stations in control of a gateway device and the base station not in control of the gateway device, a communication path which passes through the gateway device and which does not pass through a core network; and
a communication unit that performs inter-base station communications using the communication path.

5. The base station according to claim 4, wherein
the control unit determines the home base station with which the communication path should be established, on the basis of an implementation status of a handover to the home base stations from the other base station, and/or an implementation status of a handover to the other base station from the home base stations.

6. A home base station applied to a mobile communication system, comprising:
a control unit that establishes, between the home base station in control of a gateway device and the base station not in control of the gateway device, a communication path which passes through the gateway device and which does not pass through a core network; and
a communication unit that performs inter-base station communications using the communication path.

7. The home base station according to claim 6, wherein
the control unit determines whether or not to establish the communication path on the basis of an implementation status of a handover to the home base station from the other base station, and/or an implementation status of a handover to the other base station from the home base station.

8. The home base station according to claim 6, wherein
the control unit determines whether or not to establish the communication path on the basis of a reception status of a radio signal from the other base station.

9. A gateway device for managing a plurality of home base stations, comprising:
a control unit that establishes, between a home base station selected from the plurality of home base stations in control of a gateway device and other base station not in control of the gateway device, a communication path which passes through the gateway device and which does not pass through a core network; and
a communication unit that performs inter-base station communications using the communication path.

10. The gateway device according to claim 9, wherein
the control unit determines the home base station with which the communication path should be established, on the basis of an implementation status of a handover to the home base stations from the other base station, and/or an implementation status of a handover to the other base station from the home base stations.

11. The gateway device according to claim 9, wherein
the control unit determines the home base station with which the communication path should be established, on the basis of a reception status of a radio signal received in the home base stations from the other base station.
